(19) United States
(12) Patent Application Publication
(10) Pub. No.: US 2021/0331295 A1
(43) Pub. Date: Oct. 28, 2021

(54) RATCHING WRENCH

(71) Applicant: INFAR INDUSTRIAL CO., LTD., Chang-Hua County (TW)

(72) Inventor: Hsiu-Jen LIN, Chang-Hua County (TW)

(21) Appl. No.: 17/110,677

(22) Filed: Dec. 3, 2020

(30) Foreign Application Priority Data
Apr. 28, 2020 (CN) 202020672415.4

(51) Int. Cl. B25B 13/46

(52) U.S. Cl. CPC B25B 13/463

(57) ABSTRACT

A ratcheting wrench includes a body receiving a driving element, two catches, and at least one catch holder. The two catches and the at least one catch holder are biasingly connected by two position-restoring elements. The driving element is provided with ratchet teeth and the two catches have tooth portions engagable with the ratchet teeth. The tooth portion of one of the two catches is ahead of or lags behind the tooth portion of another one of the two catches by a half-tooth distance.

### BACKGROUND OF THE INVENTION

### 1. Field of the Invention

The present invention relates to an improvement of a ratcheting wrench.

### 2. Description of the Related Art

Typically, a ratcheting wrench includes a driving element provided with teeth, and a catching device provided with teeth for engaging with the driving element. Also, it is known that the number of teeth is subject to a strength-related limit, i.e., a maximum of 72. That is, in a situation where the driving element has more than 72 teeth, each of the teeth is overly small. As a result, the teeth are likely to get damaged.

Thus, the driving element has a minimum tooth-changing angle of 5 degrees approximately. Due to the aforesaid limitation, the wrench fails to work in a driving operation environment where the tooth-changing angle is less than 5 degree.

The present invention is, therefore, intended to obviate or at least alleviate the problems encountered in the prior art.

### SUMMARY OF THE INVENTION

According to the present invention, a ratcheting wrench includes a body receiving a driving element, two catches, and at least one catch holder. The two catches and the at least one catch holder are biasingly connected by two position-restoring elements. The driving element is provided with ratchet teeth and the two catches have tooth portions engagable with the ratchet teeth. The tooth portion of one of the two catches is ahead of or lags behind the tooth portion of another one of the two catches by a half-tooth distance.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is an exploded perspective view of a ratcheting wrench in accordance with a first embodiment of the present invention.

FIGS. 2 and 3 illustrate the operation of ratcheting wrench.

FIG. 4 is a cross-sectional view different from FIG. 2.

FIG. 5 is a cross-sectional view of a ratcheting wrench in accordance with a second embodiment of the present invention.

FIG. 6 is a cross-sectional view of a ratcheting wrench in accordance with a third embodiment of the present invention.

FIG. 7 is a cross-sectional view of a ratcheting wrench in accordance with a fourth embodiment of the present invention.

FIG. 8 is an exploded perspective view of a ratcheting wrench in accordance with a fifth embodiment of the present invention.

### DETAILED DESCRIPTION OF THE INVENTION

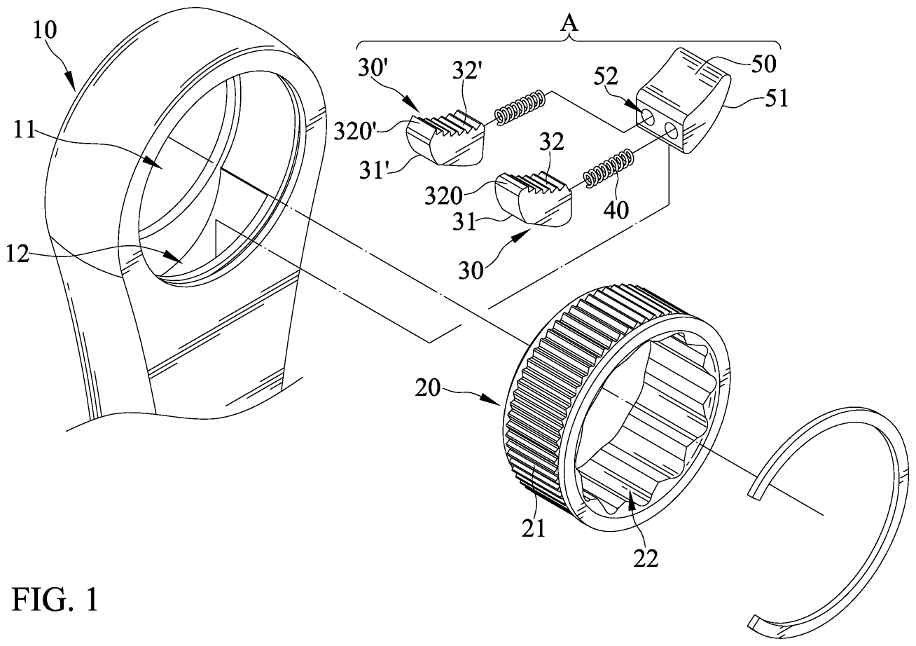

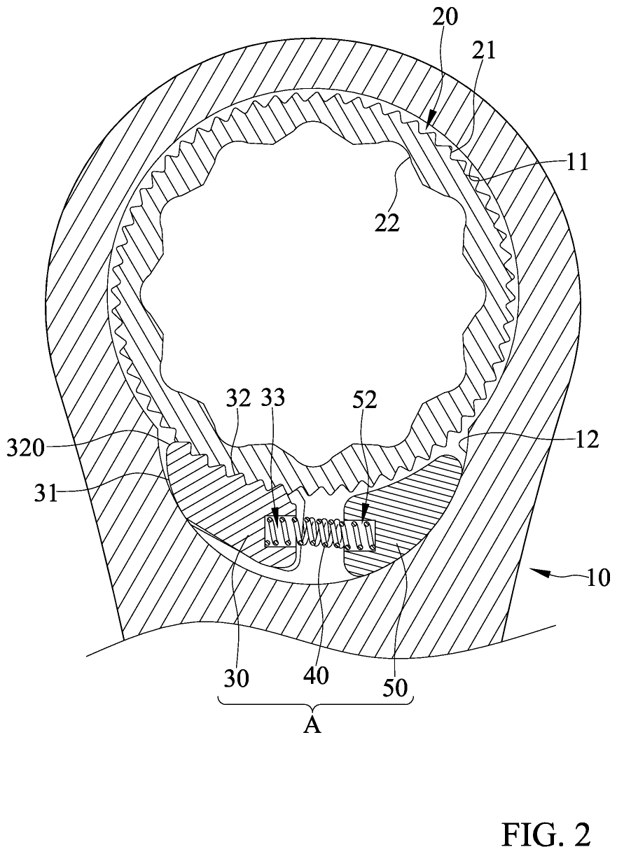

FIGS. 1 through 4 show a ratcheting wrench in accordance with a first embodiment of the present invention. The wrench has a body 10, a driving element 20, and a catching device A. The catching device A has two catches 30 and 30, two position-restoring elements 40, and a catch holder 50.

The body 10 defines a driving hole 11 and a catching chamber 12 laterally disposed about and connected to the driving hole 11. The catching chamber 12 is shallow at its two ends and deep at its middle.

The driving element 20 is provided with ratchet teeth 21 and defines a driving hole 22 for receiving a workpiece to be rotated by the wrench.

The catches 30 and 30′ are disposed in the catching chamber 12 and stacked. The catches 30 and 30′ have abutting ends 31 and 31′ abutting against the catching chamber 12 and tooth portions 32 and 32′ engagable with the ratchet teeth 21. A starting end 320 of the tooth portion 32 is in the form of a trough, whereas a starting end 320′ of the tooth portion 32′ is in the form of a peak. The tooth portion 32 is ahead of or lags behind the tooth portion 32′ by a half-tooth distance. The catches 30 and 30′ have two positioning portions 33 and 33′ keeping the two position-restoring elements 40, respectively, such that end portions of the position-restoring elements 40 are positioned in place. The positioning portions 33 and 33′ are recess. Moreover, the positioning portions 33 and 33′ are straight recesses.

The position-restoring elements 40 biasingly connects the catches 30 and 30′ and the catch holder 50. The position-restoring elements 40 have first ends abutting against the catches 30 and 30′ and second ends abutting against the catch holder 50. The catch holder 50 has an abutting surface 51 abutting against the catching chamber 12 and two positioning portions 52 keeping the two position-restoring elements 40, respectively, such that the second ends of the two position-restoring elements 40 are positioned in place. The positioning portions 52 are recess. Moreover, the positioning portions 52 are straight recesses. The two position-restoring elements 40 are straight coil springs.

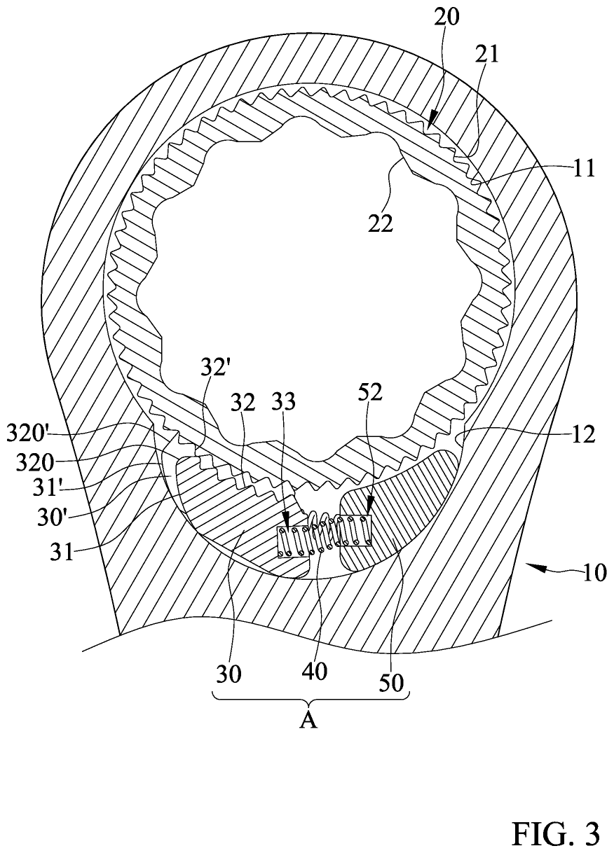

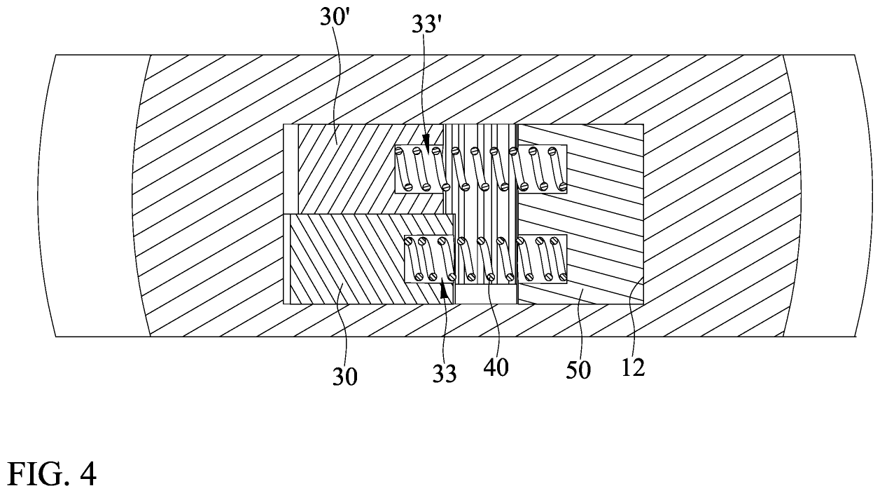

The catches 30 and 30′ can engage with the ratchet teeth 21 of the driving element 20 alternatively, i.e. in tooth engagement, as shown in FIGS. 3 and 4. Thus, a small transmission-oriented tooth-changing angle is feasible.

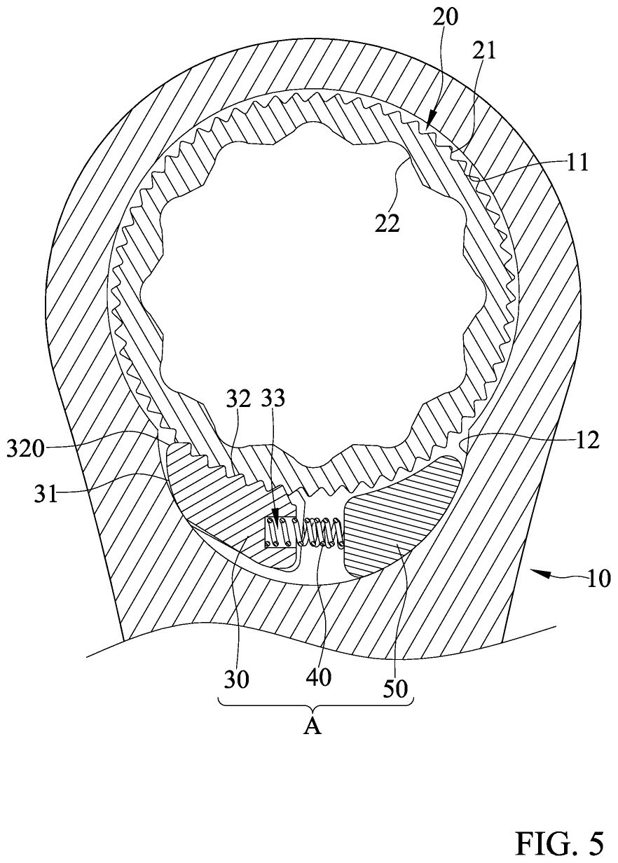

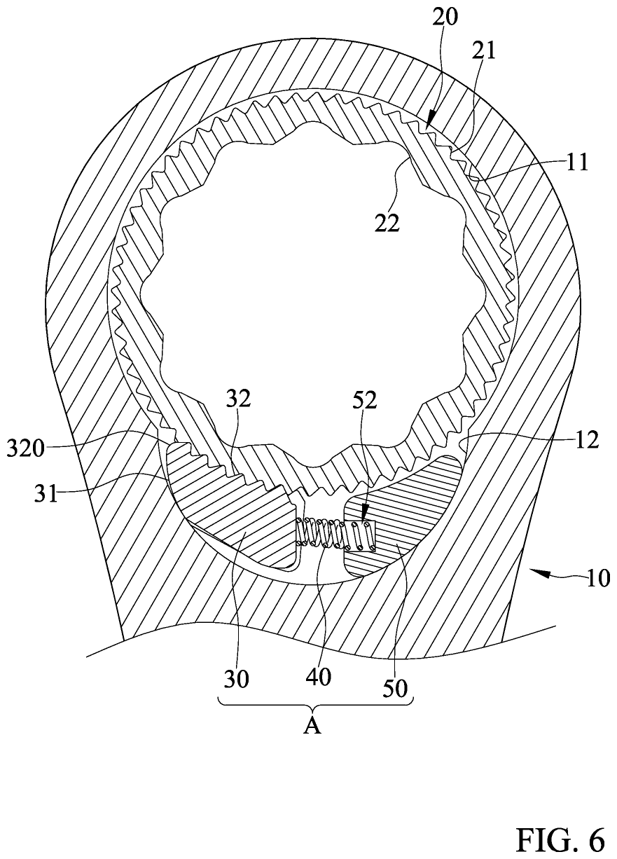

FIG. 5 shows a ratcheting wrench in accordance with a second embodiment of the present invention. The second embodiment is similar to the first embodiment except that the catch holder 50 dose not define the recessed positioning portions 52 and the position-restoring elements 40 abut against a peripheral side of the catch holder 50. FIG. 6 shows a ratcheting wrench in accordance with a third embodiment of the present invention. The third embodiment is similar to the first embodiment except that the catches 30 and 30′ don't define the positioning portions 33 and one position-restoring element 40 abuts against a peripheral side of one catch 30 and the other position-restoring element 40 abuts against a peripheral side of the other catch 30′, respectively.

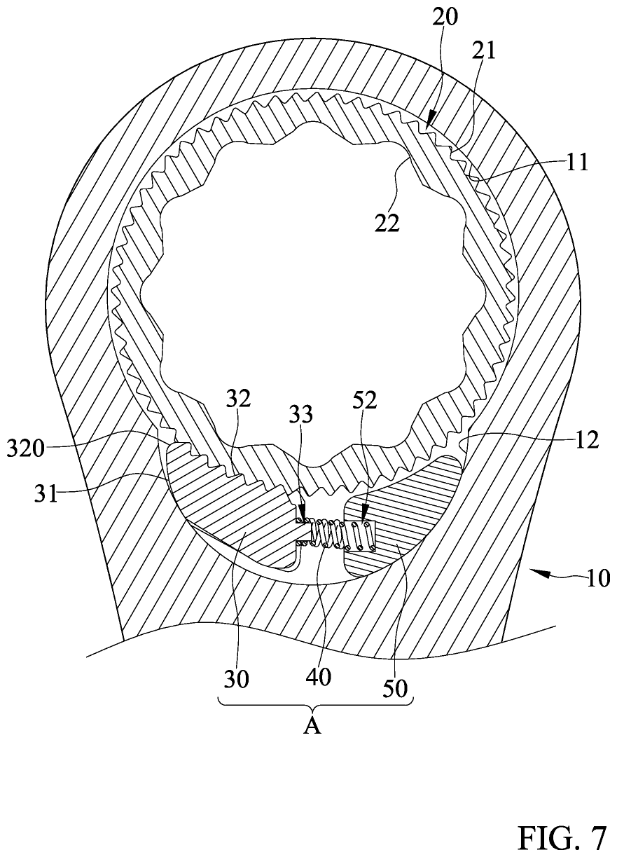

FIG. 7 shows a ratcheting wrench in accordance with a fourth embodiment of the present invention. The fourth-embodiment is similar to the first embodiment except that the positioning portions 33 and 33′ are protrusions and being cylindrical.

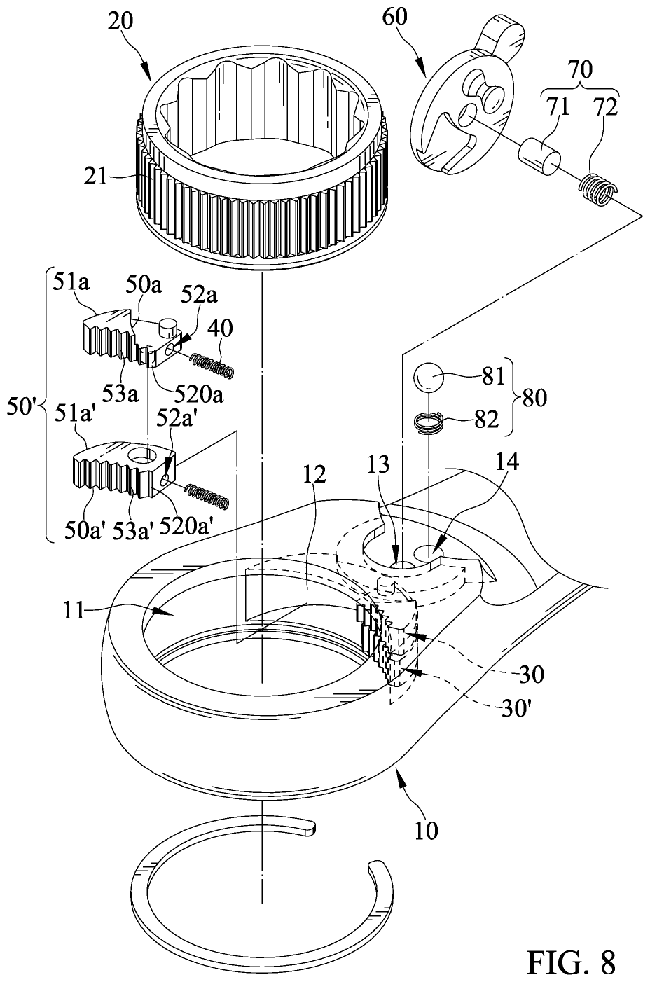

FIG. 8 shows a ratcheting wrench in accordance with a fifth embodiment of the present invention. The fifth embodiment differentiates from the first embodiment in that a set of catch holders 50′, which includes two catch holders 50a and 50a′. The catch holders 50a, 50a′ are stacked and have abutting surfaces 51a and 51a′ abutting against the catching chamber 12 and positioning portions 52a and 52a′ keeping the position-restoring elements 40. The catch holders 50a and 50a′ also have tooth portions 53a and 53a′ engagable with the ratchet teeth 21. A starting end 520a40 of the tooth portion 53a′ is in the form of a trough, whereas a starting end 520a of the tooth portion 53a is in the form of a peak. Moreover, the catch holders 50a and 50a′ can engage with the ratchet teeth 21 of the driving element 20 alternatively, like the catches 30 and 30′. In addition, a switch 60 is pivotally connected to the body 10. The body 10 defines accommodating slots 13 and 14. A switch 60 is pivotally connected to the body 10. The switch 60 is movable between two positions corresponding to a forward position and a reverse position of the ratcheting wrench. A biasing device 70 for pivotally interconnecting the switch 60 and the body 10 is received by the accommodating slot 13 and a positioning device 80 for positioning the switch 60 in the forward or reverse positions is received by the accommodating slot 14, respectively. The biasing device 70 and the positioning device 80 are disposed between the body 10 and the switch 60. The biasing device 70 includes a pivot 71 and a resilient member 72 urging the pivot 71. The positioning device 80 includes a detent 81 and a resilient member 82 urging the detent 81. The resilient members 72 and 82 are coil springs. The switch 60 joins the catch 30 and the catch holder 50 and is configured to selectively restrain the catches 30a and 30a′ and the catch holders 50a and 50a′. Particularly, the switch 60 selectively restrain the catches 30a and 30a′ when in one of two positions and the catch holders 50a and 50a′ in the other of the two positions.

In view of the foregoing, the catches 30 and 30′ engage with the driving element 20 alternatively, so a small transmission-oriented tooth-changing angle is feasible. Furthermore, the position-restoring elements 40 are stably retained and thus, providing a stable driving effect and facilitates the assembly of the ratcheting wrench.

The foregoing is merely illustrative of the principles of this invention and various modifications can be made by those skilled in the art without departing from the scope and spirit of the invention.

What is claimed is:

1. A ratcheting wrench comprising:
a body receiving a driving element, two catches and at least one catch holder, wherein the two catches and the at least one catch holder are biasingly connected by two position-restoring elements, wherein the driving element is provided with ratchet teeth and the two catches have tooth portions engagable with the ratchet teeth, wherein the tooth portion of one of the two catches is ahead of or lags behind the tooth portion of another one of the two catches by a half-tooth distance, and wherein the two catches engage with the ratchet teeth alternatively.

2. The ratcheting wrench as claimed in claim 1, wherein the at least one catch holder includes two catch holders, wherein the two catch holders have tooth portions engagable with the ratchet teeth, wherein the two catches and the two catch holders are selectively restrained by a switch, and wherein the switch is movably connected to the body and being movable between two positions corresponding to a forward position and a reverse position of the ratcheting wrench.

3. The ratcheting wrench as claimed in claim 1, wherein the two catches are stacked.

4. The ratcheting wrench as claimed in claim 2, wherein the two catches the two catch holders are stacked and the two catch holders are stacked.

5. The ratcheting wrench as claimed in claim 1, wherein the tooth portion has a starting end in the form of a trough, and the tooth portion has a starting end in the form of a peak.

6. The ratcheting wrench as claimed in claim 1, wherein the two catches have two positioning portions keeping first ends of the two position-restoring elements and the at least one catch holder has two positioning portions keeping second ends of the two position-restoring elements, respectively.

7. The ratcheting wrench as claimed in claim 2, wherein the two catches have two positioning portions keeping first ends of the two position-restoring elements and the two catch holders has positioning portions keeping second ends of the two position-restoring elements, respectively.

8. The ratcheting wrench as claimed in claim 6, wherein the two positioning portions of the two catches are recesses.

9. The ratcheting wrench as claimed in claim 6, wherein the two positioning portions of the two catches are protrusions.

10. The ratcheting wrench as claimed in claim 7, wherein the two positioning portions of the at least one catch holder are recesses.

11. The ratcheting wrench as claimed in claim 2, wherein the tooth portion has a starting end in the form of a trough, and the tooth portion has a starting end in the form of a peak.

12. The ratcheting wrench as claimed in claim 3, wherein the tooth portion has a starting end in the form of a trough, and the tooth portion has a starting end in the form of a peak.

13. The ratcheting wrench as claimed in claim 4, wherein the tooth portion has a starting end in the form of a trough, and the tooth portion has a starting end in the form of a peak.

14. The ratcheting wrench as claimed in claim 3, wherein the two catches have two positioning portions keeping first ends of the two position-restoring elements and the at least one catch holder has two positioning portions keeping second ends of the two position-restoring elements, respectively.

15. The ratcheting wrench as claimed in claim 4, wherein the two catches have two positioning portions keeping first ends of the two position-restoring elements and the two catch holders has positioning portions keeping second ends of the two position-restoring elements, respectively.

16. The ratcheting wrench as claimed in claim 8, wherein the two positioning portions of the at least one catch holder are recesses.

17. The ratcheting wrench as claimed in claim 9, wherein the two positioning portions of the at least one catch holder are recesses.
